(19) United States
(12) Patent Application Publication
(10) Pub. No.: US 2010/0102706 A1
(43) Pub. Date: Apr. 29, 2010

(54) ELECTROLUMINESCENT DEVICE WITH INCREASED FILL FACTOR

(76) Inventors: Michael E. Miller, Honeoye Falls, NY (US); Liang-Sheng Liao, Rochester, NY (US)

Correspondence Address: J. Lanny Tucker, Patent Legal Staff,;Eastman Kodak Company, 343 State Street, Rochester, NY, 14650-2201, US

(21) Appl. No.: 12/259,321

(22) Filed: Oct. 28, 2008

(51) Int. Cl. H01J 1/88

(52) U.S. Cl. 313/494

(57) ABSTRACT

An electroluminescent device including at least two spaced-apart electrodes wherein at least a portion of each of the two spaced-apart electrodes overlap within a first area and a second portion of the two spaced-apart electrodes do not overlap within a second area; a light-emitting layer having a first resistivity formed between the two electrodes, the light-emitting layer disposed to overlap at least a portion of both the first and second areas; a carrier-diffusing layer formed between the light-emitting layer and one of the spaced-apart electrodes; the carrier-diffusing layer disposed to overlap the light-emitting layer in at least a portion of both the first and second areas; and wherein the carrier-diffusing layer has a second resistivity selected to be lower than the first resistivity to cause light to be produced by the light-emitting layer within the first and second areas.

### FIELD OF THE INVENTION

The present invention relates to electroluminescent devices having spaced-apart electrodes with one of the electrodes being patterned to form two individual electrode segments. Specifically, the invention relates to an electroluminescent device capable of producing light within the area between the individual electrode segments to obtain improved fill factor.

### BACKGROUND OF THE INVENTION

Many display and lighting devices exist within the market today. Among the technologies that are employed within these markets are thin-film electroluminescent devices, including organic light-emitting diode (OLED) devices. Electroluminescent (EL) devices are generally constructed by forming an EL layer between a pair of electrodes. Generally, at least one of these electrodes is patterned, producing gaps between adjacent patterned electrode segments. In these devices, electrons and holes are introduced into the EL layers by the electrodes and are localized onto the EL molecules that are located between the two electrodes. As a result, these light-emitting devices emit light in the regions defined by the overlap of the two electrodes but do not emit light in the regions where no electrode is present or regions where only one electrode is present.

FIG. 1 depicts this relationship between electrode structure and light-emitting area. As shown in this figure, a first electrode 4 is formed from vertical stripes across a device 2 and a second electrode 6 is formed from horizontal stripes across the device 2. Such an EL device will emit light within regions 8 defined by the intersection of these electrodes but will not emit light in the remaining regions 10 in which no electrodes are present or only one of the two electrodes (e.g., 4 or 6) are present. This relationship between electrode structure and light-emitting area has certain advantages within some applications. For example, in displays, the ability to quickly transition from areas with no light emission to areas with peak light emission permits the display to present very sharp and crisp images. In lighting applications, different EL materials for producing different colors of light emission can be positioned over different electrode segments and current to each electrode segment can be modified to change the color of light-emission in a controlled fashion.

Despite these advantages, the localization of light-emission within EL devices to the areas of the electrodes has some significant disadvantages. First, as these electrode segments are formed, the size of the gaps between the electrode segments directly influence the fill factor of the light-emitting element, wherein the fill factor represents the ratio of the size of the light-emitting portion of each light-emitting element to the size of the area allocated for each light-emitting element on the EL device. As the size of the gap between electrode segments is increased relative to the overall light-emitting element size, this fill factor is decreased. Unfortunately, decreasing the size of the gap between electrode segments typically requires more expensive manufacturing processes and decreases overall manufacturing yield. Therefore, it is desirable to permit devices to be formed with as large a gap between electrode segments as possible. However, in most EL devices, and especially in OLED devices, the fill factor is related to lifetime of the device. This relationship is typically modeled through the use of a second order or higher polynomial fit, therefore, increases in fill factor are highly desirable to improve the overall lifetime of the device.

Having light-emitting elements with limited fill factors also produces significant artifacts within displays. For example, it is well understood that limited fill factor produces images with artifacts such as increased visibility of so called “jaggies”, in which diagonal lines appear as stair steps rather than smooth lines, and the screen door effect, in which the inactive areas between light-emitting regions are perceptible and appear to overlay regions of uniform luminance. As a result, the literature provides multiple methods for improving the fill factor of displays. For example, it is known that optical elements can be included to improve the fill factor of pixels in a display. Chiu et al. in U.S. Pat. No. 5,929,962 discusses the use of optical elements to increase the perceived fill factor of a liquid crystal display. Thielemans in European Patent Application EP 1 780 798 describes the formation of curved reflectors behind LEDs with relatively small aperture ratios to increase the fill factor to nearly 100%. Unfortunately, while these methods increase the perceived fill factor of the device, they do not increase the actual fill factor and therefore do not have positive effects upon the lifetime of the device.

Significant work has also been done to simply reduce the area between light-emitting regions. In active matrix displays, the size of the areas between light-emitting elements is not only influenced by the ability to pattern gaps but also by active electronics that are often formed between these electrode segments. In such displays, it is known to decrease the area required for forming electronics. For instance, commonly used electrical components can be stacked vertically and insulated from one another as described by Gu in U.S. Pat. No. 5,920,084. While such processes add additional cost to the development of such displays, this patent demonstrates the importance of increasing the fill factor of light-emitting elements within display applications.

In lighting devices, it is typically important to provide diffuse, uniform illumination. The visibility of these segments can reduce the uniformity of the light, however, external diffusing layers, typically including arrays of lenses or diffusing particles can be used to improve uniformity. For instance Foust et al. in U.S. Pat. No. 7,348,738 describes the use of a diffusing layer together with a pixelated OLED. This diffusing layer has the ability to diffuse the light generated within one OLED into the inter-area between OLEDs, increasing the perceived uniformity and fill factors of the pixilated OLEDs. However, depending upon the location and design of these diffusing layers, they can reduce the light output from the device and again do not affect the area of the electroluminescent layer that is stimulated to produce light output.

### SUMMARY OF THE INVENTION

There is a need for an improved EL device having an increased fill factor to provide an improved lifetime and their luminance uniformity. This increase in fill factor should be achieved without increasing the resolution of patterning technology to reduce the area between electrodes. This object is achieved by providing an electroluminescent device including:

(a) at least two spaced-apart electrodes wherein at least a portion of each of the two spaced-apart electrodes overlap within a first area and a second portion of the two spaced-apart electrodes do not overlap within a second area;

(b) a light-emitting layer having a first resistivity formed between the two electrodes, the light-emitting layer disposed to overlap at least a portion of both the first and second areas;

(c) a carrier-diffusing layer formed between the light-emitting layer and one of the spaced-apart electrodes; the carrier-diffusing layer disposed to overlap the light-emitting layer in at least a portion of both the first and second areas; and

(d) wherein the carrier-diffusing layer has a second resistivity selected to be lower than the first resistivity to cause light to be produced by the light-emitting layer within the first and second areas.

The present invention enables EL devices to emit light in areas, which do not contain electrode segments. As such, these devices can emit light between pairs of neighboring electrode segments, thereby improving the fill factor and consequently the lifetime and uniformity of the resulting device. This technology can also increase the gap size between electrode segments without loss of fill factor, thereby reducing manufacturing tolerances for patterning of electrode segments.

### BRIEF DESCRIPTION OF THE DRAWINGS

FIG. 1 a plan view illustrating a device of a prior art device;

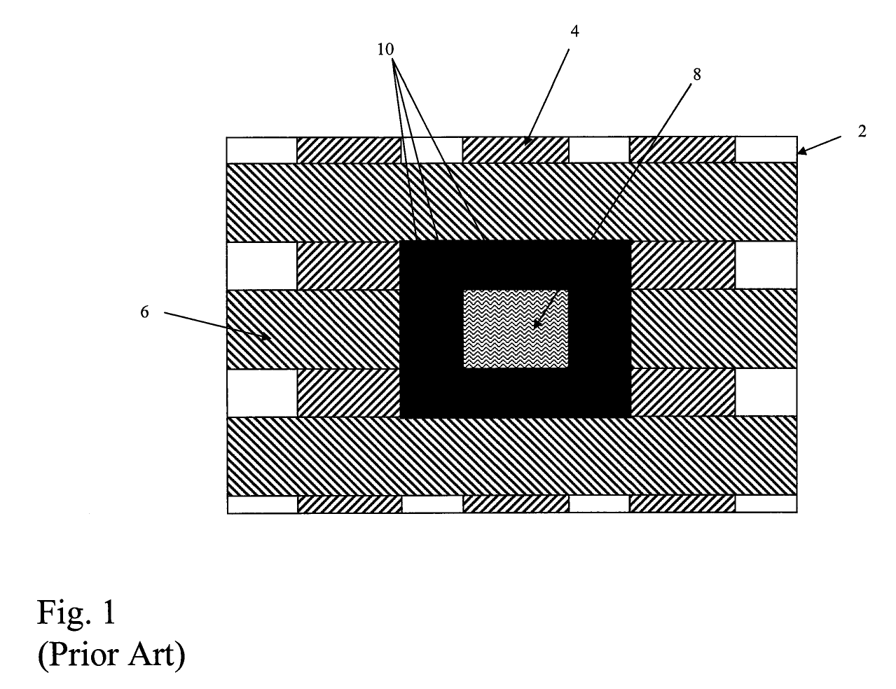

FIG. 2 a cross-sectional diagram illustrating a device of the present invention;

FIG. 3 a plan view illustrating a device of the present invention;

FIG. 4 a cross-sectional view illustrating a device of the present invention;

FIG. 5 a plan view illustrating the spatial relationship of the cathodes, anodes, and EL layers in exemplary devices of the present invention;

FIG. 6 shows an exemplary device according to the prior art;

FIG. 7 a representation of an exemplary device according to the present invention; and

FIG. 8 a plan view illustrating an illumination source of the present invention.

### DETAILED DESCRIPTION OF THE INVENTION

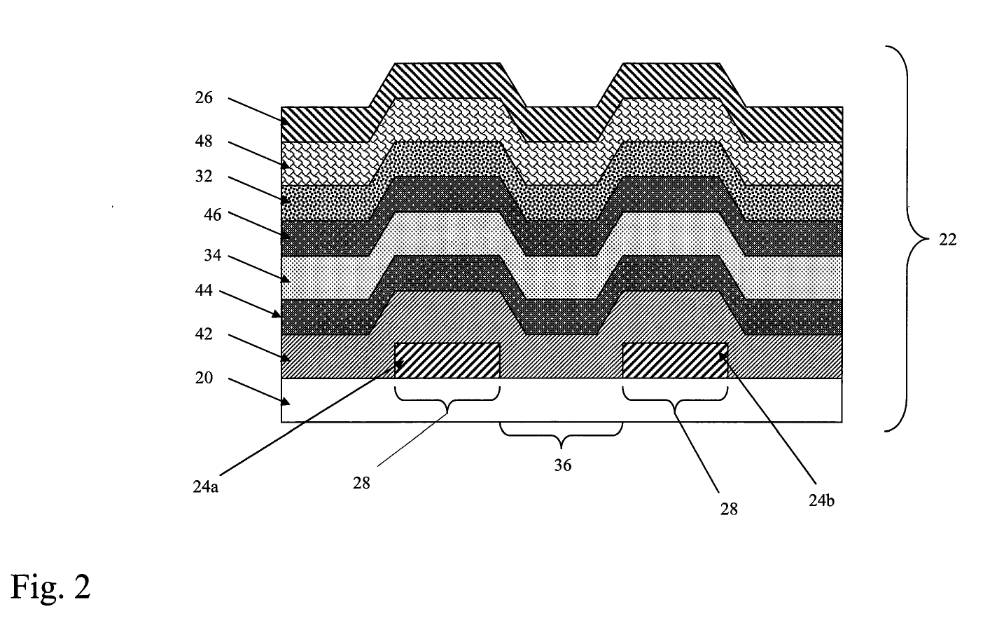

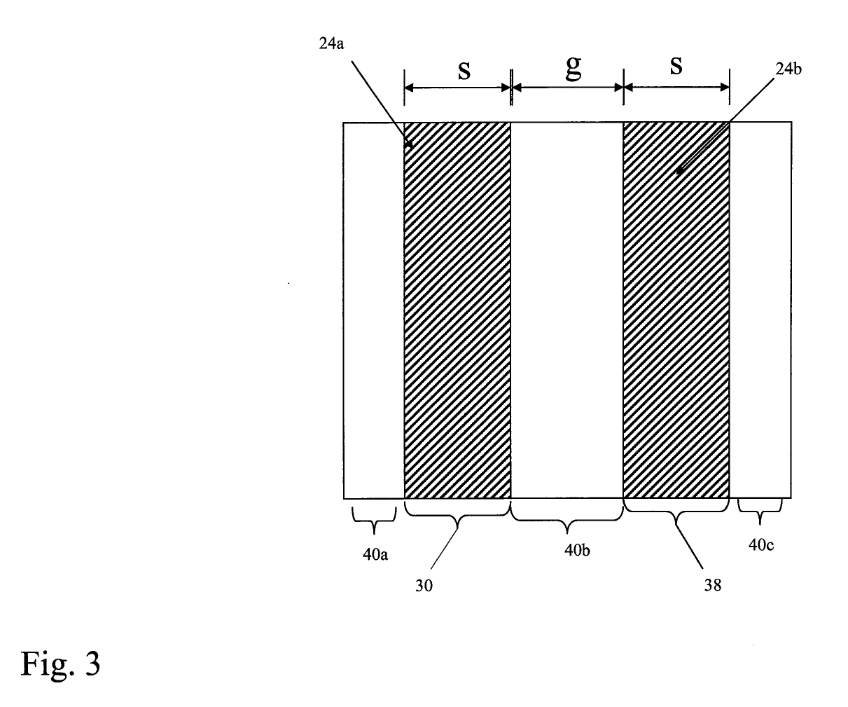

The need is met by providing an electroluminescent (EL) device as shown in FIG. 2 and FIG. 3. FIG. 2 shows a cross-section of a thin film EL device, specifically an OLED device, of the present invention. As shown in this figure, the OLED device 22 includes at least two spaced-apart electrodes 24, 26. These electrodes are spaced apart by numerous EL material layers 42, 44, 34, 46, 32, 48. In the embodiment shown, one of the two spaced-apart electrodes 24 is patterned to form a plurality of individual, spaced, neighboring segments 24a, 24b. Within this configuration a first area 28 is formed in which the first and second spaced-apart electrodes 24, 26 overlap one another. A second area 36 is also formed in which the spaced-apart electrodes 24, 26 do not overlap. The device further includes a light-emitting layer 32 having a first resistivity (r1) formed between the two spaced-apart electrodes 24, 26. This light-emitting layer 32 is disposed to overlap at least a portion of both the first 28 and second 36 areas. A carrier-diffusing layer 34 is also formed between the light-emitting layer 32 and one of the two spaced-apart electrodes 24, 26. This carrier-diffusing layer 34 is disposed to overlap the light-emitting layer 32 in at least a portion of both the first 28 and second 36 areas. Further, this carrier-diffusing layer 34 will have a second resistivity (r2) lower than the first resistivity (r1). In devices, such as the one shown in FIG. 2 in which one of the electrodes is formed from two individual segments 24a, 24b, this carrier-diffusing layer 34 will be formed over at least a portion of one of the individual segments 24a, 24b, the presence of which define the first area 28 in FIG. 2 and over the second area 36 between two of the individual segments 24a, 24b. Because this carrier-diffusing layer 34 is lower in resistivity than the light-emitting layer 32, it promotes the lateral diffusion of carriers within the electroluminescent device beyond the boundaries of the individual segments 24a, 24b. That is, it permits carriers (holes or electrons) to migrate laterally within the device before encountering the light-emitting layer 32. As a result, hole and electron pairs are able to combine on molecules within the light-emitting layer 32 in both the first area 28 and the second area 36 even though at least one of the two spaced-apart electrodes 24, 26 are not present within the second area 36. As such, light emission can occur outside the first area 28 that is defined by the overlap of the two spaced-apart electrodes 24, 26, thus increasing the effective fill factor beyond the fill factor defined by the overlap of the two spaced-apart electrodes.

As shown in FIG. 2, the EL device 22 will typically be formed on a substrate 20. The first, spaced-apart electrode 24 can be an anode layer, which is formed on the substrate 20. Additional layers, such as a hole injection layer 42 or a hole transport layer 44 will typically be formed between the first electrode and the carrier-diffusing layer 34. These layers can be important in some circumstances to prevent the formation of shorts between individual segments 24a, 24b and the carrier-diffusing layer 34. An additional hole transport layer 46 can be formed over the carrier-diffusing layer 34 before deposition of the light-emitting layer 32. Additional EL layers 48 for performing functions such as hole blocking, electron transport or electron injection can then be formed between the light-emitting layer 32 and the second electrode layer 26. The spaced-apart electrodes will include both an anode and a cathode. Multiple layers of materials, including at least a light-emitting layer and a carrier-diffusing layer, will separate these electrodes. Each of the spaced-apart electrodes can be formed from a single uniform coating or can be patterned to form individual segments. The individual segments of any one of the electrodes will typically be formed in a single plane within the EL device and will serve as either an anode or a cathode.

FIG. 3 shows a top view of the OLED device 22 with the first, spaced-apart electrode 24 forming individual segments 24a, 24b that are spaced within the plane of the electrode and at least pairs of these individual segments 24a, 24b which are adjacent to one another. By stating that these individual segments are adjacent to one another it is intended that some distance separates these segments within the plane of the electrode and that no electrode segment is between the adjacent individual segments. According to the prior art, an EL device will produce illumination within the areas 30, 38 defined by the overlap of the electrode segments 24a, 24b with a second spaced apart electrode 26. However, according to the present invention, the carrier-diffusing layer 34 permits the carriers, specifically the holes in the device depicted in FIG. 2, to diffuse into the areas 40a, 40b, and 40c which are outside the areas 30, 38 defined by the individual segments 24a, 24b and therefore light will be generated by the portions of the light-emitting layer 32 which is not directly between the overlapping spaced-apart electrodes 24, 26, that is, portions of the light-emitting layer 32 that lie within the area 40b and between the areas 30, 38 defined by the spaced-part segments 24a, 24b. Further, light can be created by the light-emitting layer within areas 40a, 40c which are beyond the edges of the neighboring segments 24a, 24b.

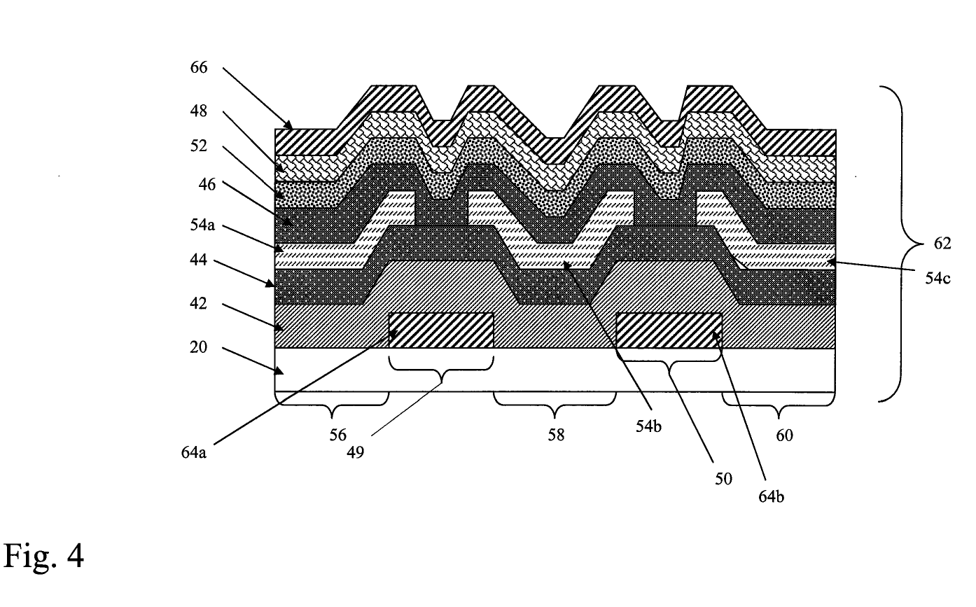

Although the device shown in FIG. 2 and FIG. 3 included at least one electrode layer 24 that was patterned to form a plurality of neighboring segments 24a, 24b and an unpatterned carrier-diffusing layer 34, it is also possible to pattern the carrier-diffusing layer 34. This carrier-diffusing layer 34, however, can not be patterned exactly in register with the segments of each of the at least one patterned electrode layer but must overlap at least a portion of the light-emitting layer which overlaps the area 40b between the neighboring segments 24a, 24b and potentially areas 40a, 40c beyond the edges of the neighboring segments 24a, 24b. The cross-section of such a device is shown in FIG. 4.

The EL device 62 depicted in FIG. 4 is similar to FIG. 2 in that it includes two spaced-apart electrodes 64, 66, one of which 64 is patterned to form a plurality of neighboring segments 64a, 64b. The presence of these individual segments 64a, 64b define first areas 49, 50 and the absence of these same individual segments 64a, 64b define second areas 56, 58, 60. A light-emitting layer 52 is formed between the two spaced-apart electrodes 64, 66 and is disposed to overlap at least a portion of a first area 49, 50 and second area 56, 58, 60. However, the one layer that is different in FIG. 4 as compared to FIG. 2 is the carrier-diffusing layer 54. Within this figure, the carrier-diffusing layer 54 is patterned into segments 54a, 54b, and 54c. As shown each of these segments 54a, 54b, and 54c are disposed within a portion of a first area 49, 50 and a second area 56, 58, 60 and overlap the light-emitting layer within the regions in which it is disposed. As before, when this carrier-diffusing layer 54 has a second resistivity that is less than the first resistivity of the light-emitting layer The carrier-diffusing layer permits carriers (e.g., holes or electrons) to diffuse within the carrier-diffusing layer 54 and permits the light-emitting layer 52 to produce light within the second area 56, 58, 60 even though one of the two spaced-apart electrodes 64 is not present within the second areas 56, 58, 60. In this embodiment, at least one of the two spaced-apart electrodes 64, 66 includes at least two individual segments 64a, 64b and activation of either of the at least two individual segments causes light to be produced by the light-emitting layer within the second area 56, 58, 60.

The remainder of the device of FIG. 4 is similar to the device of FIG. 2, including a substrate 20 on which the first, spaced-apart electrode 64 is formed. Additional layers, such as a hole injection layer 42 or a hole transport layer 44 will typically be formed between the first electrode and the carrier-diffusing layer 54. These layers can be important in some circumstances to prevent the formation of shorts between individual segments 64a, 64b and the carrier-diffusing layer 54 and thus provide a shorting reduction layer. An additional hole transport layer 46 can be formed over the carrier-diffusing layer 54 before deposition of the light-emitting layer 52. Additional EL layers 48 for performing functions such as hole blocking, electron transport or electron injection can then be formed between the light-emitting layer 52 and the second electrode layer 66.

Within these embodiments, the spread of the carriers and therefore the distribution of light that is produced by the light-emitting layer can be controlled by controlling the relative resistivity of the layers, thickness of the layers, the size of the individual segments 64a, 64b and the space between adjacent individual segments 64a, 64b. Specifically, assuming that the light-emitting layer 32 or 52 has a thickness d1 and a resistivity r1, the carrier-diffusing layer 34 or 54 has a thickness d2 and a resistivity r2, the smallest dimension of one of the adjacent, individual segments is s and the space between two of the adjacent, individual segments is g, light will be emitted over a significant portion of the second area 56, 58, 60 as long as the relationship specified by the following inequality is satisfied:

(r2/r1)×s×g<9×d1×d2.

Note that the distances s and g are depicted in FIG. 3, with s representing the smallest dimension of the electrodes 24a and 24b and g representing the distance between the nearest edges of the two adjacent, spaced individual segments 24a, 24b. As expressed in this relationship, as long as the quantity obtained by multiplying the ratio of the second resistivity to the first resistivity multiplied by the smallest dimension s and the space between the two adjacent individual segments g is less than 9 times the quantity obtained by multiplying the thickness of the light-emitting layer and the thickness of the carrier-diffusing layer, significant light emission will occur within the second areas.

In each of the previous embodiments, at least one carrier transport layer (e.g., a hole or electron transport layer was located between one of the electrodes and the light-emitting layer. The presence of such a layer is significant as it provides both a carrier transport and provides a high resistivity spacer between the electrode and the carrier-diffusing layer to prevent shorts. That is this carrier transport layer provides the function of a short reduction layer. It is therefore, important that this shorting reduction layer will typically have a resistivity that is significantly (often more than an order of magnitude) higher than the resistivity of the carrier-diffusing layer.

### COMPARATIVE EXAMPLE

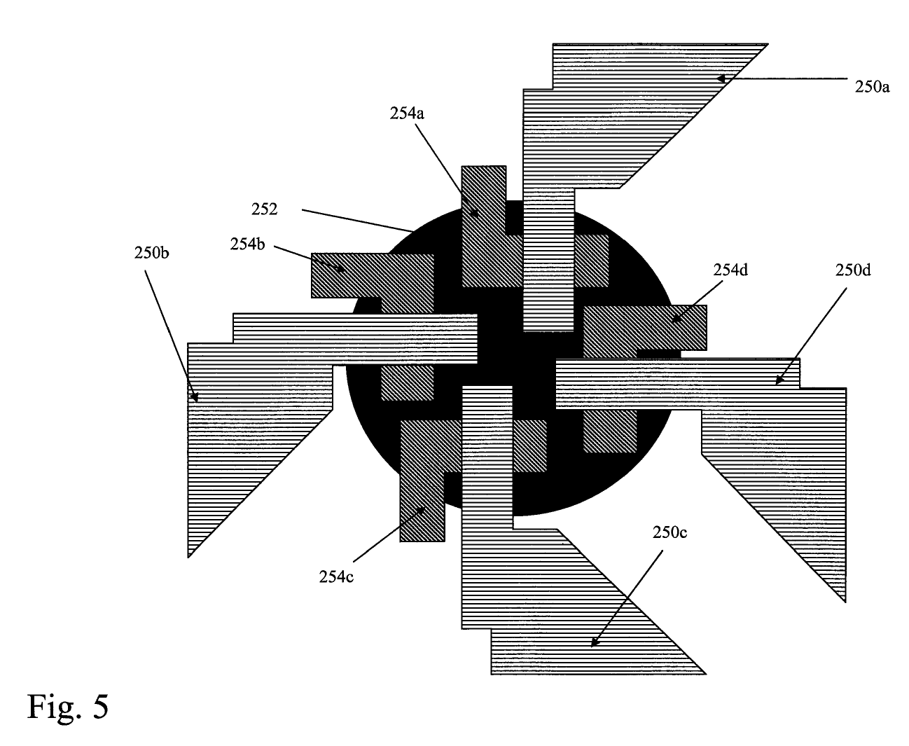

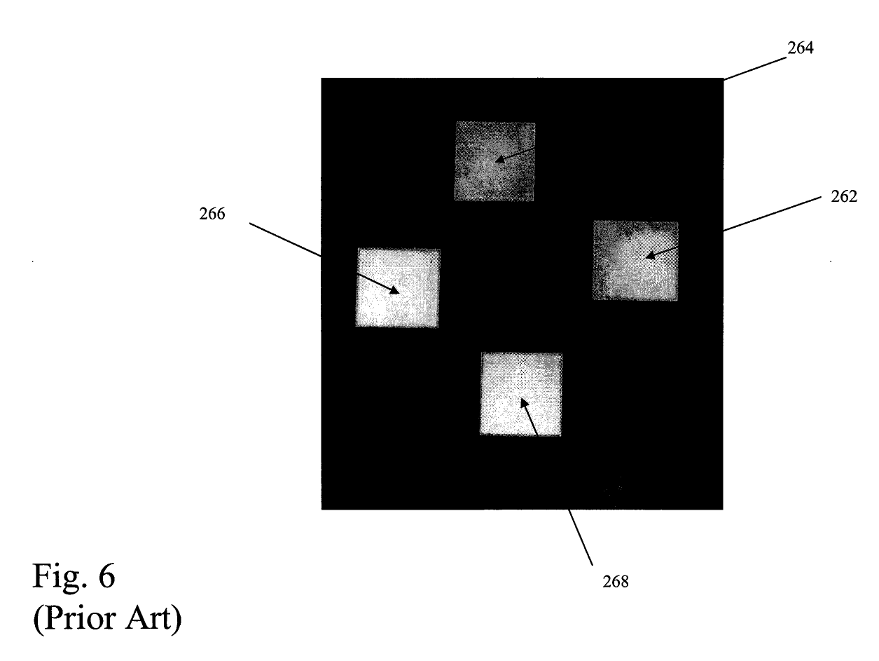

To demonstrate the concept of a device according to the present invention, a pair of devices was constructed. Each of these devices used an arrangement of cathode and anode segments as depicted in FIG. 5. As shown in this figure, four separate anode leads 250a, 250b, 250c, 250d were formed from ITO on a glass substrate. These anode leads form the first of two spaced-apart electrodes. The four separate anode leads each correspond to an individual electrode segment of the present invention. A series of electroluminescent layers were then coated over these anode leads in the area indicated by the circle 252. Finally, a silver cathode was deposited through a shadow mask to form the cathode segments 254a, 254b, 254c, 254d, and thus forming individual, spaced electrode segments. These anode and cathode leads, that are overlapping but spaced-apart by the series of electroluminescent layers, are partially coincident when viewed from a direction perpendicular to the substrate. In this comparative example, a traditional OLED structure was formed having two EL structures, each containing an electroluminescent light-emitting layer. Specifically, each EL structure contains a hole injection layer, a hole transport layer, an electron blocking layer, a doped light-emitting layer, and an electron transport layer. The layers of this device and the thickness of the each of these layers are shown in Table 1. The device functions as a voltage is applied between the anode and cathode of the device, holes are injected from the ITO anode into a first EL structure and electrons are injected from the metal cathode into a second EL structure. The electric field that is produced simultaneously permits the connecting layer to inject electrons into the first EL structure towards the anode and provide a flow of holes into the second EL structure towards the cathode. These carriers are then supported as they move through the device until encountering the doped, light-emitting layers, where light is generated. However, in this device, the lateral resistance of the layers between the anode and the cathode are much higher than the vertical resistance of the layers due to the huge dimensional difference of these materials which have a thickness on the order of 100s of Angstroms and a horizontal dimension on the order of a cm. Therefore, the carriers are not diffused but follow a relatively straight line path between the anode and cathode. As a result, light emission only occurs within the regions defined by the coincident portions of the anode leads 250 and the cathode segments 254 as shown in FIG. 6.

TABLE 1

| Layer | Thickness (Angstroms) |
|---|---|
| Anode (ITO) | 100 |
| Hole Injection Layer | 750 |
| Hole Transport Layer | 750 |
| Electron Blocking Layer | 100 |
| First Doped Light-Emitting Layer | 200 |
| Electron Transport Layer | 250 |
| Connecting Layer | 150 |
| Hole Injection Layer | 100 |
| Hole Transport Layer | 550 |
| Electron Blocking Layer | 100 |
| Second Doped Light-Emitting Layer | 200 |
| Electron Transport Layer | 200 |
| Electron Injection Layer | 150 |
| Cathode | 800 |

FIG. 6 provides an representation of the organic light-emitting device of the comparative example. As shown in this figure, light emission occurs only at the intersection of the anode leads 250 and the cathode segments 254, producing the squares of light-emission 262, 264, 266, and 268. Light is not produced in any other regions of the device.

### INVENTIVE EXAMPLE

In this example, a device that was nearly identical to the device provided in the comparative example was formed. The layers of this device are provided in Table 2. It should be noted that these layers are identical except that the 100 Angstrom thick carrier-diffusing layer was formed between the connecting layer and the hole injecting layer of the second EL structure. In this particular device, this layer was formed from silver to insure that it would have a low resistivity as compared to the resistivity of the light-emitting layer.

TABLE 2

| Layer | Thickness (Angstroms) |
|---|---|
| Anode (ITO) | 100 |
| Hole Injection Layer | 750 |
| Hole Transport Layer | 750 |
| Electron Blocking Layer | 100 |
| First Doped Light-Emitting Layer | 200 |
| Electron Transport Layer | 250 |
| Connecting Layer | 150 |
| Carrier-diffusing Layer | 100 |
| Hole Injection Layer | 100 |
| Hole Transport Layer | 550 |
| Electron Blocking Layer | 100 |
| Second Doped Light-Emitting Layer | 200 |
| Electron Transport Layer | 200 |
| Electron Injection Layer | 150 |
| Cathode | 800 |

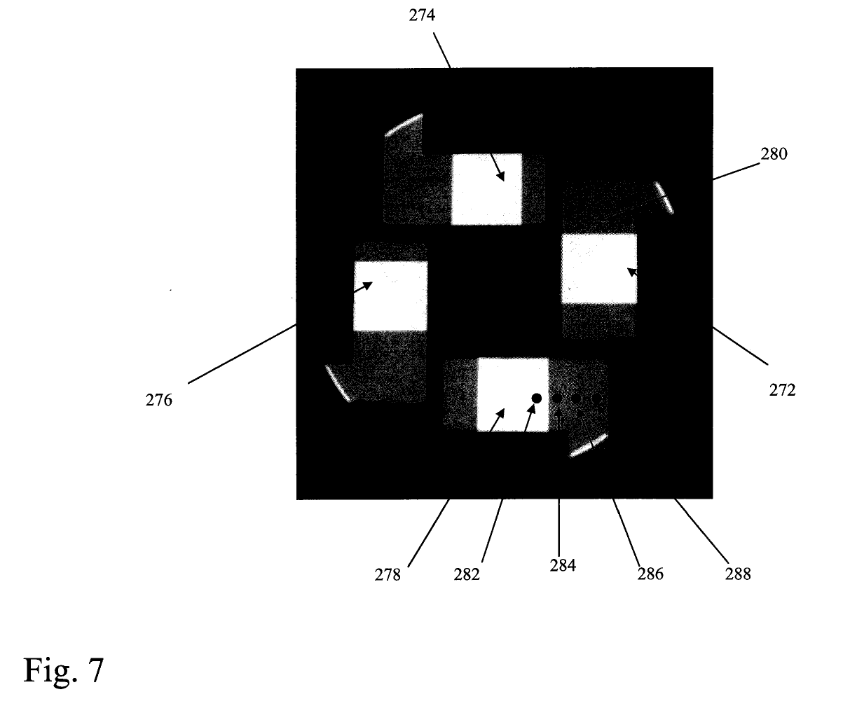

In this device, the carrier-diffusing layer served to diffuse the electrons within the device, permitting light to be emitted within the area of the cathode even though the anode was only located be coincident with a small region of the cathode. The embodiment shown in FIG. 7 demonstrates this diffusion. This device includes four high luminance areas 272, 274, 276, and 278 which provide a high level of illumination and are formed at the intersection of the anode leads 250 and the cathode segments 254. These areas are approximately the same areas as are illuminated in the comparative example shown in FIG. 6.

In addition to these areas, light is also emitted along other portions of the cathode, such as in region 280. It is important to note, however, that the actual luminance provided by the light-emitting element does decrease somewhat as the distance from the areas 272, 274, 276, and 278 is increased. This can be illustrated through photometric measurements recorded at each of four measurement locations within a light-emitting element, including locations 282, 284, 286, and 288. Within this device, the relative intensity at location 282 was 4.49 nits. This value decreases to 0.709 nits at location 284, 0.644 nits at location 286 and 0.600 nits at location 288. This demonstrates the fact that this carrier-diffusing layer permits a larger portion of the light-emitting layer to be activated including portions of the light-emitting layer that is outside the spatial region defined by the intersection of the anode and cathode segments (i.e., the two spaced-apart electrodes). Further, it demonstrates that as the distance from this intersection is increased, the luminance output by the light-emitting layer decreases.

The cross section of the devices shown in FIG. 2 and FIG. 4 each included a single light-emitting layer. However, the current invention can also be practiced with devices having multiple light-emitting layers that are spaced apart by other transport layers. The device shown in the inventive example is one such device having multiple light-emitting layers. Looking back at Table 2, this device has a first doped light-emitting layer that is spaced from the anode by a hole injection, hole transport and electron blocking layer. These layers, together with the electron transport layer closest to the anode form a first EL structure with the connecting layer serving as the electrode for this EL structure. The device also has a second doped light-emitting layer that is spaced from the first doped light-emitting layer by an electron transport layer, a connecting layer, the carrier-diffusing layer and second hole injection, hole transport and electron blocking layers. The connecting layer serves as the anode for a second EL structure which is formed from the hole injection layer, hole transport layer, electron blocking layer, electron injection layer and cathode that are constructed on top of it. Notice that in this device, the holes pass through the first light-emitting layer before encountering the carrier-diffusing layer. This layer then diffuses the holes before encountering the second light-emitting layer. As such, only the second light-emitting layer contributes to the illumination that is produced outside the intersection of the patterned anode and cathode, which accounts for the large drop in luminance outside the area of the intersection of the patterned anode and cathode. Therefore, it is possible to control the amount of diffused light by the placement of the carrier-diffusing layer within devices with multiple EL structures that are connected in series, as are the two EL structures in this example. That is, by increasing the number of light-emitting layers on one side of the carrier-diffusing layer as opposed to the other side, the ratio of light produced in the area of intersecting, spaced-apart electrodes with regard to the light produced outside this area can be controlled.

In this example, the electroluminescent device included at least two spaced-apart electrodes wherein at least a portion of each of the two spaced-apart electrodes overlap within a first area and a second portion of the two spaced-apart electrodes do not overlap within a second area; two separate EL structures disposed between the two spaced-apart electrodes and a connecting layer connecting the two EL structures, each EL structure having a light-emitting layer having a particular resistivity, each light-emitting layer disposed to overlap at least a portion of both the first and second areas; a carrier-diffusing layer formed between one of the light-emitting layers and one of the spaced-apart electrodes; the carrier-diffusing layer disposed to overlap the light-emitting layer in at least a portion of both the first and second areas; and wherein the carrier-diffusing layer has a second resistivity selected to be lower than the resistivity of one of the light-emitting layers to cause light to be produced by the light-emitting layer within the first and second areas. As shown, the carrier-diffusing layer affected only the light output of one of the two separate EL structures due to its placement. However, it should be noted that placing the carrier-diffusing layer in this example in the device such that it is separated from the anode by at least one organic layer, such as a hole injection layer, the carrier-diffusing layer can be made to affect the light output of both of the EL structures. It should further be noted that the carrier-diffusing layer can be placed either within or outside of one or more than one of the EL structures in order to be effective.

Although the previous example provided a discussion of an OLED device the present invention can be applied in any thin film coated electroluminescent diode device according to the present invention. This device can be any thin film, coated electroluminescent device that can be used to form light-emitting diodes between a pair of electrodes. These devices can include organic electroluminescent materials, including a light-emitting layer 32, 52, employing purely organic small molecule or polymeric materials, typically including organic hole transport, organic light-emitting and organic electron transport layers as described in the prior art, including U.S. Pat. No. 4,769,292 to Tang et al., and U.S. Pat. No. 5,061,569 to VanSlyke et al. The electroluminescent materials, including the light-emitting layer 32, 52, can alternately be formed from a combination of organic and inorganic materials, typically including organic hole transport and electron transport layers in combination with inorganic light-emitting layers, such as the light-emitting layers described in U.S. Pat. No. 6,861,155 to Bawendi et al. Other layers, such as the electron or hole transport layers can alternatively be formed from inorganic semiconductors and applied with either organic or inorganic light-emitting layers. These inorganic hole or electron transport layers can be annealed to alter their resistivity and permit them to serve as the carrier-diffusing layer.

In yet another alternative embodiment, the electroluminescent materials, including the light-emitting layer 32, 52, can be formed from fully inorganic materials such as the devices described in U.S. Patent Application Publication No. 2007/0057263. Note such devices can include a carrier-diffusing layer that is formed by annealing an inorganic semiconductor material. In such devices, the resistivity of the layer can be controlled by the annealing conditions and the ratio of the resistivity of the light-emitting layer to the resistivity of the carrier-diffusing layer can be controlled to control the length of light emission beyond the boundary of the electrodes. These devices can also include quantum dots within their light-emitting layer, as described within this patent application.

Although, the basic concept of the present invention can be applied within devices of each of the classes that are mentioned in the previous paragraph, the exact mechanism by which this concept will be implemented will likely be different. For example, the resistances of most organic semiconductors, which are useful in the formation of the layers of an OLED device, are often very similar to each other. Therefore, in these devices, the carrier-diffusing layer 34, 54 will likely be formed from a class IB transition metal such as silver but can be formed from a composite layer including these transition metals or can include an inorganic semiconductor or organic semiconductor having a lower resistance than the light-emitting layer. In a device formed predominantly from inorganic semiconductors, the resistance of potential materials can vary over well more than an order of magnitude and therefore, the carrier-diffusing layer 34, 54 will likely be formed from an inorganic semiconductor material. This inorganic semiconductor can serve other purposes within the device, such as serving as the hole or electron transport layer while also serving as the carrier-diffusing layer 34, 54. Further the ratio of the resistance of vertical resistance through the light-emitting layer to the vertical resistance through the carrier-diffusing layer 34, 54 can be adjusted by adjusting the thickness of one or more of these layers. That is, the thickness of the inorganic light-emitting layer 32, 54 can be adjusted to increase its resistance, such that its vertical resistance is higher than the lateral resistance through the carrier-diffusing layer 34, 54. This fact is due to the fact the ratio of the thickness of the light-emitting layer to the thickness of the carrier-diffusing layer is proportional to the ratio of the second resistivity to the first resistivity.

Based on this discussion, the carrier-diffusing layer can be formed from Group IB transition metals or from type II-VI and III-V semiconductors. The carrier-diffusing layer can also be formed from organic semiconductor materials having a high mobility, for example PEDOT. Group IB transition metals include silver as demonstrated in the previous example. Type II-VI and III-V semiconductors include ZnSe or ZnS. Additional dopants such as Al, In, or Ga can be used to dope the Type II-VI and III-V semiconductors, which are commonly n-type semiconductors, to form p-type semiconductors using these same materials. Carrier-diffusing layers formed from n-type semiconductors will typically be useful to transport electrons while p-type semiconductors will typically be more useful to transport holes. As noted earlier, changes in layer thickness, annealing conditions and others can be used to form a carrier-diffusing layer that has a lower resistivity than the light-emitting layer in order to form a carrier-diffusing layer within a device that employs a carrier-diffusing layer formed from type II-VI or III-V semiconductors. While the type II-VI and III-V semiconductors can be applied in devices such as the ones described by Kahen, hybrid devices can also be created.

As electrical shorts between the carrier-diffusing layer and the electrodes can provide devices with undesirable attributes, any of these devices can include thin layers of high resistivity directly over the electrode to serve as a shorting reduction layer. For instance, in devices employing primarily organic electroluminescent materials, wherein the carrier-diffusing layer is a Group IB transition metal, this carrier-diffusing layer can be separated from each of the electrodes by at least one layer of organic material. This organic material will typically provide the function of carrier injection or transport and will prevent shorts between individual segments within a single electrode. Other materials having a high resistivity, such as indium oxide, gallium oxide, zinc oxide, tin oxide, molybdenum oxide, vanadium oxide, antimony oxide, bismuth oxide, rhenium oxide, tantalum oxide, tungsten oxide, niobium oxide, or nickel oxide, can be employed to form an appropriate shorting reduction layer between one of the electrodes and the carrier-diffusing layer. These oxides can further be combined with one another, and or an electrically insulating oxide, fluoride, nitride, or sulfide material to form appropriate shorting reduction layers. Further, in inorganic devices that employ annealing to decrease resistivity of the carrier-diffusing layer, flash heating or other methods can be used to anneal only portions of the carrier-diffusing layer that is farthest from the electrode such that resistance of the material is higher near the electrode than further from the electrode.

Particularly in devices in which the resistivity of the different layers is selectable or controllable, the distance over which light-emission will occur beyond the edge of a first area, corresponding to the location of overlapping portions of spaced-apart electrode segments, can be controlled by changing the resistivity or the thickness of the layers. For example, the thickness of the light-emitting layer can be varied to satisfy the following relationship:

d1>=((r2/r1)×sL/9)/d2

to control the length (L) over which light-emission will occur beyond the edge of the first area. In this equation the thickness (d1) of the light-emitting layer is determined as the ratio of the resistivity of the carrier-diffusing layer to the resistivity of the light-emitting layer multiplied by the quantity achieved by multiplying the smallest dimension (s) of the electrode segment by the length L, divided by 9. The resulting value is then divided by the thickness (d2) of the carrier-diffusing layer to obtain the thickness d1 of the light-emitting layer. Generally, the light obtained will not end simultaneously but will decrease gradually within the second areas of the device. In some preferred embodiments, the distribution of light that is produced by the light-emitting layer between the two individual segments decreases as the distance between the adjacent two individual segments increases such that the point of half amplitude occurs at or before the midpoint between the two individual, spaced, adjacent segments. The midpoint is the point half way between the nearest edges of two adjacent, spaced individual segments. As such, while the light will be diffused due to the presence of the carrier-diffusing layer, light emission will generally be confined to the area of a single addressable element within the final device, resulting in a minimal loss of sharpness as compared to a device without the carrier-diffusing layer while having the positive benefit of increased aperture ratio.

Although not shown in the previous embodiments, it is also possible for both of the two spaced-apart electrodes to be patterned and for light to be produced outside the area defined by the intersection of the segments of the two spaced-apart electrodes. One embodiment of such a device can include a passive matrix of anode and cathode elements wherein the EL layers between these two spaced-apart electrodes includes a carrier-diffusing layer.

Devices of the present invention can be useful in various applications. As noted in the prior art section, diffusers have been used in conjunction with displays, particularly large displays to provide a uniform appearance. Therefore, it is reasonable that such a device can be employed to form a display in which each of the individual segments are individually addressable to permit images to be created.

Other applications of the current technology include illumination sources. It is known to construct lamps as illumination sources from coatable EL materials such as discussed within this disclosure. These illumination sources typically are required to create a diffuse illumination profile. To achieve this diffuse illumination profile, devices known in the art can include external diffusers, which require the construction of external structures which increase the cost of the device or that absorb a portion of the light that is emitted by the device, reducing the efficiency of the device. However, by applying devices of the present invention in the construction of an illumination source the efficiency of the device is not decreased by the external diffuser, the addition of this carrier-diffusing layer is very cost effective as compared to external diffusers and devices of the present invention will have a higher effective fill factor than devices formed with patterned electrodes. These higher effective fill factors will decrease the average current density in the device, increasing the average lifetime of the device.

The use of a carrier-diffusing layer of the present invention is particularly useful when diffuse light is required from an EL source that produces polarized light. Coatable EL devices, such as described by Culligan et al. in U.S. Pat. No. 7,037,599 are known in the art for producing polarized light. Such devices are particularly useful when creating backlights for displays, for creating other illumination sources where polarized light is required or for creating polarized light from a display for directing light as can be required in a stereographic display. In these devices, the light-emitting layer forms polarized light. However, the use of external diffusive elements for diffusing the light generally scatters the light and will therefore depolarize at least a portion of the emitted light. Devices of the present invention, however, diffuse the carriers before light-emission occurs. Therefore, when the light-emitting layer in a device of the present invention creates polarized light, it is capable of emitting this light across the entire surface of the device. Therefore, the device is capable of emitting diffuse, polarized light.

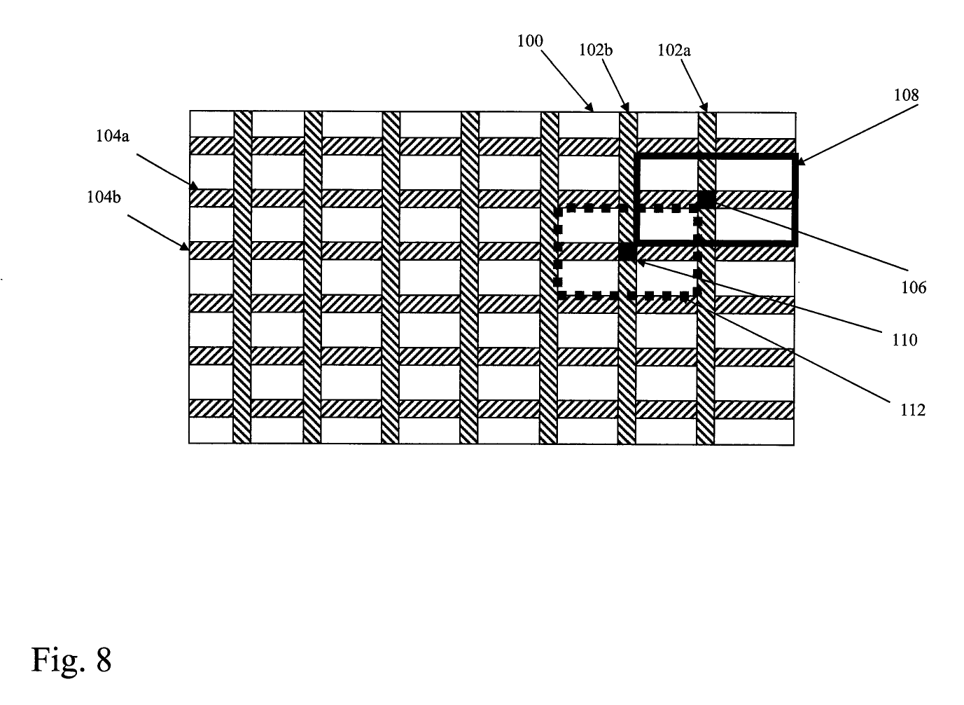

In a particularly desirable embodiment, a device of the present invention can be used to create a patterned, addressable polarized backlight for a light modulator, such as a liquid crystal display. The top view of one such backlight is shown in FIG. 8. As shown in this figure, the device can be coated on a substrate 100. The device will include a series of row electrode segments, including electrode segments 104a, 104b and a series of column electrodes, including electrode segments 102a, 102b. The series of electrode segments will provide a series of individually-addressable, individual electrode segments. These electrodes will be spaced apart by the EL layers of the device. The device will include at least one carrier-diffusing layer for diffusing at least one of the carriers but ideally will include two carrier-diffusing layers, one which is deposited before a light-emitting layer for diffusing either holes or electrons and a second carrier-diffusing layer deposited after the light-emitting layer for diffusing the other of the holes or electrons. The EL layers will be directly stimulated by the electrode segments 102a, 102b at the intersection of these two spaced-apart electrodes, shown by area 106 in FIG. 8. However, due to the carrier-diffusing layers, both electrons and holes will diffuse, one in the horizontal and one in the vertical direction. Therefore, light emission will occur within the area 108 when an electrical potential is placed between electrode segments 102a and 104a. Similarly, when an electrical potential is placed between another pair of electrodes, for example 102b and 104b the EL layers will be directly stimulated by the electrodes at the intersection 110 of these two electrodes. However, due again to the presence of the carrier-diffusing layers the carriers will diffuse to produce light emission within the area 112. As such, diffuse light can be created from an array of individual, spaced-apart electrode segments. In configurations, in which this device is used to serve as an illumination source for a light modulator, the light emission created by the stimulation of each pair of electrodes will illuminate a two-dimensional array of subpixels on the light modulator. Such a device can serve as an addressable light modulator in high dynamic range display. In the case where this light modulator is to serve as a light modulator for a liquid crystal display, the light-emitting layer will ideally emit polarized light.

The invention has been described in detail with particular reference to certain preferred embodiments thereof, but it will be understood that variations and modifications can be effected within the spirit and scope of the invention.

### PARTS LIST

2 device
4 first electrode
6 second electrode
8 regions
10 remaining regions
20 substrate
22 OLED device
24 spaced-apart electrode
24a individual segment of spaced-apart electrode
24b individual segment of spaced-apart electrode
26 spaced-apart electrode
28 first area
30 first area
32 light-emitting layer
34 carrier-diffusing layer
36 second area
38 first area
40a second area
40b second area
40c second area
42 hole injection layer
44 hole transport layer
46 hole transport layer
48 additional EL layers
49 first area
50 first area
52 light-emitting layer

### Parts List Cont'

54 carrier-diffusing layer
54a segment of carrier-diffusing layer
54b segment of carrier-diffusing layer
54c segment of carrier-diffusing layer
56 second area
58 second area
60 second area
62 EL device
64 spaced-apart electrode
64a individual segment of spaced-apart electrode
64b individual segment of spaced-apart electrode
66 spaced-apart electrode
100 substrate
102a electrode segment
102b electrode segment
104a electrode segment
104b electrode segment
106 intersection area
108 light emission area
110 intersection area
112 light emission area
250a anode lead
250b anode lead
250c anode lead
250d anode lead
252 circle of EL layers

### Parts List Cont'd

254a cathode segment
254b cathode segment
254c cathode segment
254d cathode segment
262 light-emission square
264 light-emission square
266 light-emission square
268 light-emission square
272 high luminance area
274 high luminance area
276 high luminance area
278 high luminance area
280 region
282 measurement location
284 measurement location
286 measurement location
288 measurement location

1. An electroluminescent device including:
(a) at least two spaced-apart electrodes wherein at least a portion of each of the two spaced-apart electrodes overlap within a first area and a second portion of the two spaced-apart electrodes do not overlap within a second area;
(b) a light-emitting layer having a first resistivity formed between the two electrodes, the light-emitting layer disposed to overlap at least a portion of both the first and second areas;
(c) a carrier-diffusing layer formed between the light-emitting layer and one of the spaced-apart electrodes; the carrier-diffusing layer disposed to overlap the light-emitting layer in at least a portion of both the first and second areas; and
(d) wherein the carrier-diffusing layer has a second resistivity selected to be lower than the first resistivity to cause light to be produced by the light-emitting layer within the first and second areas.

2. The electroluminescent device of claim 1, further including a shorting reduction layer located between one of the electrodes and the light-emitting layer.

3. The electroluminescent device of claim 2, wherein the shorting reduction layer includes organic material and wherein the carrier-diffusing layer includes a Group IB transition metal.

4. The electroluminescent device of claim 1, wherein the carrier-diffusing layer includes an inorganic semiconductor material.

5. The electroluminescent device of claim 1 wherein at least one of the two spaced-apart electrodes includes at least two individual, spaced, adjacent segments and wherein activation of either of the at least two individual segments causes light to be produced by the light-emitting layer within both the first and second areas.

6. The electroluminescent device of claim 5, wherein the light-emitting layer has a thickness d1 and a resistivity r1 and the carrier-diffusing layer has a thickness d2 and a resistivity r2, the smallest dimension of one of the at least two individual segments is s and the space g between two adjacent individual segments satisfies the relationship (r2/r1)×s×g<9×d1×d2.

7. The electroluminescent device of claim 6, wherein the two adjacent individual segments have a smallest dimension s and a between segment spacing of g and wherein the light-emitting layer includes an inorganic semiconductor material having a thickness d1 and a resistivity r1, wherein the thickness (d1) of the inorganic light-emitting layer is selected to satisfy the relationship d1>=((r2/r1)×sL/9)/d2 to provide a resistance higher than the resistance of the carrier-diffusing layer.

8. The electroluminescent device of claim 5, wherein the distribution of light that is produced by the light-emitting layer between two spaced, adjacent individual segments decreases as the distance between the two adjacent individual segments increases such that the point of half amplitude of light occurs at or before the midpoint between the two adjacent individual segments.

9. The electroluminescent device of claim 5, wherein each of the two spaced-apart electrodes are patterned.

10. The electroluminescent device of claim 9, further including a passive matrix for driving the spaced-apart electrodes.

11. The electroluminescent device of claim 1, wherein the electroluminescent device is an illumination source.

12. The electroluminescent device of claim 1, wherein the device is an addressable backlight for a display employing a light modulator.

13. The electroluminescent device of claim 5, wherein the device is a display.

14. The electroluminescent device of claim 1, wherein the light-emitting layer includes quantum dots.

15. The electroluminescent device of claim 1, wherein the ratio of the thickness of the light-emitting layer to the thickness of the carrier-diffusing layer is proportional to the ratio of the first resistivity to the second resistivity.

16. The electroluminescent device of claim 1, wherein the carrier-diffusing layer is an annealed inorganic semiconductor material.

17. An electroluminescent device including:
(a) at least two spaced-apart electrodes wherein at least a portion of each of the two spaced-apart electrodes overlap within a first area and a second portion of the two spaced-apart electrodes do not overlap within a second area;
(b) two separate EL structures disposed between the two spaced-apart electrodes and a connecting layer connecting the two EL structures, each EL structure having a light-emitting layer having a particular resistivity, each light-emitting layer disposed to overlap at least a portion of both the first and second areas;
(c) a carrier-diffusing layer formed between one of the light-emitting layers and one of the spaced-apart electrodes; the carrier-diffusing layer disposed to overlap the light-emitting layer in at least a portion of both the first and second areas; and
(d) wherein the carrier-diffusing layer has a second resistivity selected to be lower than the resistivity of one of the light-emitting layers to cause light to be produced by the light-emitting layer within the first and second areas.
